(19) United States
(12) Patent Application Publication
(10) Pub. No.: US 2008/0010778 A1
(43) Pub. Date: Jan. 17, 2008

(54) Hydraulic hinge

(76) Inventor: Shu Tse, Kowloon (CN)

Correspondence Address: ALIX YALE & RISTAS LLP, 750 MAIN STREET, SUITE 1400, HARTFORD, CT, 06103, US

(21) Appl. No.: 11/712,079

(22) Filed: Feb. 28, 2007

(30) Foreign Application Priority Data
Jul. 11, 2006 (HK) 06107748.4

(51) Int. Cl. E05F 5/02

(52) U.S. Cl. 16/82

(57) ABSTRACT

A hydraulic hinge for the lid of a food serving vessel in a buffet restaurant includes a hinge block, a shaft pivotally mounted to the hinge block, an annular hydraulic chamber within the hinge block and at least partially surrounding the shaft, and a one-way valve having an inlet port and an outlet port each communicating with the hydraulic chamber and allowing hydraulic fluid to flow from the inlet port to the outlet port but not vice versa. The hinge further includes a rotary piston extending from the shaft across the annular hydraulic chamber and adapted to pivot with the shaft between the inlet and outlet ports and comprising a flow restrictor allowing hydraulic fluid to flow relatively slowly therethrough. This prevents the lid from dropping after patrons release the lid.

### BACKGROUND OF THE INVENTION

The present invention relates to hinges. More particularly, although not exclusively, the invention relates to a hinge for the lid of a buffet serving vessel.

Buffet restaurants provide a number of self-service vessels situated about a counter area. Each vessel is usually made of stainless steel and comprises a stainless steel lid having a handle by which each restaurant patron pivotally raises the lid to reveal the vessel's contents for self-service usually with a spoon or tongs.

After finishing with each vessel, the patrons often drop the lid causing it to bang closed. This can be annoying to other restaurant patrons.

### OBJECTS OF THE INVENTION

It is an object of the present invention to overcome or substantially ameliorate the above disadvantage and/or more generally to provide a hydraulic damping hinge for the lid of a buffet restaurant food vessel.

### DISCLOSURE OF THE INVENTION

There is disclosed herein a hydraulic hinge for a lid of a food serving vessel, comprising:
a hinge block,
a shaft pivotally mounted to the hinge block,
an annular hydraulic chamber within the hinge block and at least partially surrounding the shaft, and
a one-way valve having an inlet port and an outlet port each communicating with the hydraulic chamber and allowing hydraulic fluid to flow from the inlet port to the outlet port but not vice versa.

Preferably, the hinge further comprises a rotary piston extending from the shaft across the annular hydraulic chamber and adapted to pivot with the shaft between the inlet and outlet ports and comprising a flow restrictor allowing hydraulic flow therethrough.

Preferably, the one-way valve comprises a spring and a ball situated between the inlet and outlet ports.

Preferably, the hinge further comprises a seal plate through which the shaft passes and a sealing to the hinge block.

Preferably, the hinge further comprises a hinge block cover through which the shaft also passes and attached to the hinge block and covering the seal plate.

### BRIEF DESCRIPTION OF THE DRAWINGS

A preferred form of the present invention will now be described by way of example with reference to the accompanying drawings, wherein:

FIG. 1 is a schematic perspective illustration of a buffet restaurant hot food serving vessel having its lid mounted on a hydraulic hinge,

FIG. 2 is a schematic elevation of one of the hinge blocks,

FIG. 3 is a schematic elevation of the other hinge block, FIG. 4 is a schematic parts-exploded perspective illustration of the components of one of the hinge blocks,

FIG. 5 is a schematic cross-sectional plan of one of the hinge blocks, and

FIGS. 6 to 8 are schematic cross-sectional elevations of the hinge block showing a number of pivotal orientations of its shaft.

### DESCRIPTION OF THE PREFERRED EMBODIMENTS

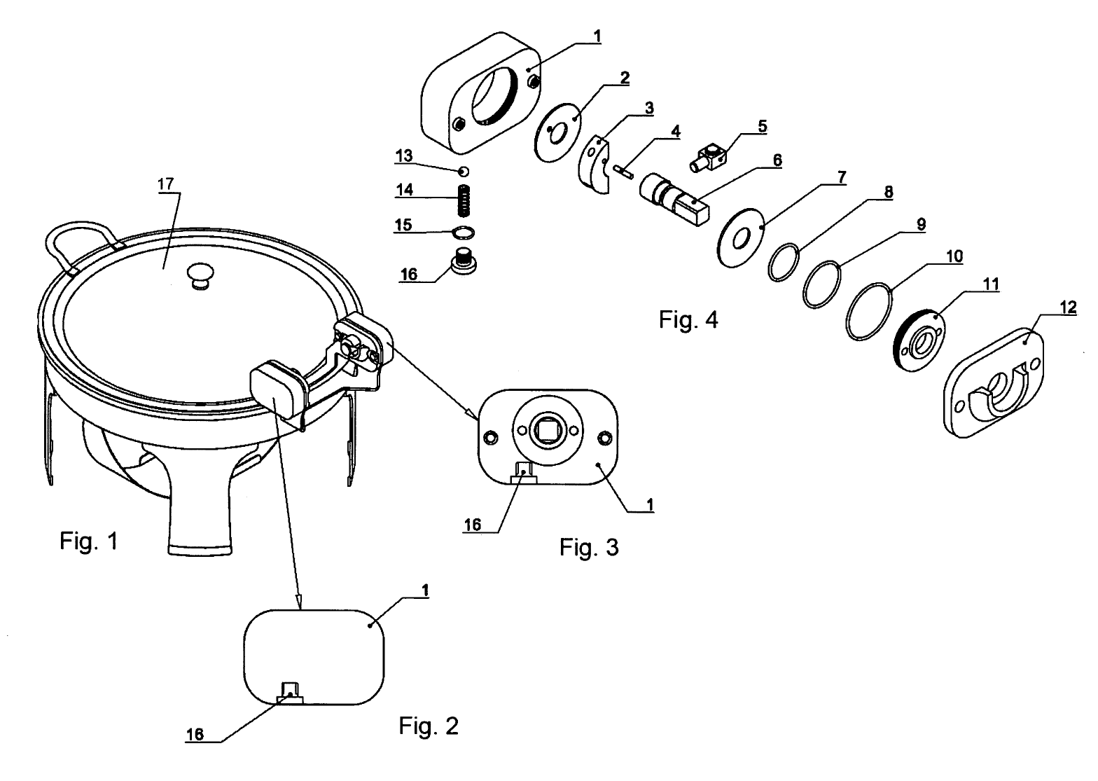

In FIG. 1 of the accompanying drawings there is depicted schematically a lid of 17 of a buffet restaurant serving vessel pivotally mounted by a hinge at 18. The hinge comprises a pair of hinge blocks to be described in detail below. One hinge block is the mechanical mirror of the other.

The components of one of the hinge blocks are shown in FIGS. 4 to 8.

Hinge block 1 is typically made of stainless steel or aluminium alloy for example and comprises a cylindrical recess defining a hydraulic chamber 18 through which a shaft 6 extends. The lid 17 of the serving vessel is mounted to the shaft 6.

The shaft 6 is located centrally of the hydraulic chamber 18 and is sealed to the hinge block 1 by a seal plate 11. An o-ring 8 surrounds the shaft 6 and seals against the inner periphery of the seal plate 11. Beneath the seal plate 11 is a washer 2. A pair of further O-rings 9 and 10 fit into respective annular recesses on the underside of the seal plate 11. These bear against the upper surface of the washer 2. At the base of the hydraulic chamber 18, there is provided a further washer 7. This washer locates the bottom of the shaft 6 centrally of the hydraulic chamber.

Also located within the hydraulic chamber is a one-way valve 3. The valve 3 is held in position within the hinge block 1 by a retaining pin 4. Within the valve there is located a ball 13 biased against a seat by a spring 14 which is retained by a retainer 16 that is screw-fitted into an access bore of the hinge block 1. An O-ring 15 seals the retainer 16.

The one-way valve 3 comprises an inlet port 19 and an outlet port 20. These both communicate with the hydraulic chamber 18. The ball 13 and spring 14 allow hydraulic fluid to flow from the inlet port 19 to the outlet port 20, but prevent backflow of hydraulic fluid in the opposite direction.

Extending radially of the shaft 6 is a rotary piston 5. The outer extremity of the rotary piston 5 seals against the cylindrical wall of the hydraulic chamber 18.

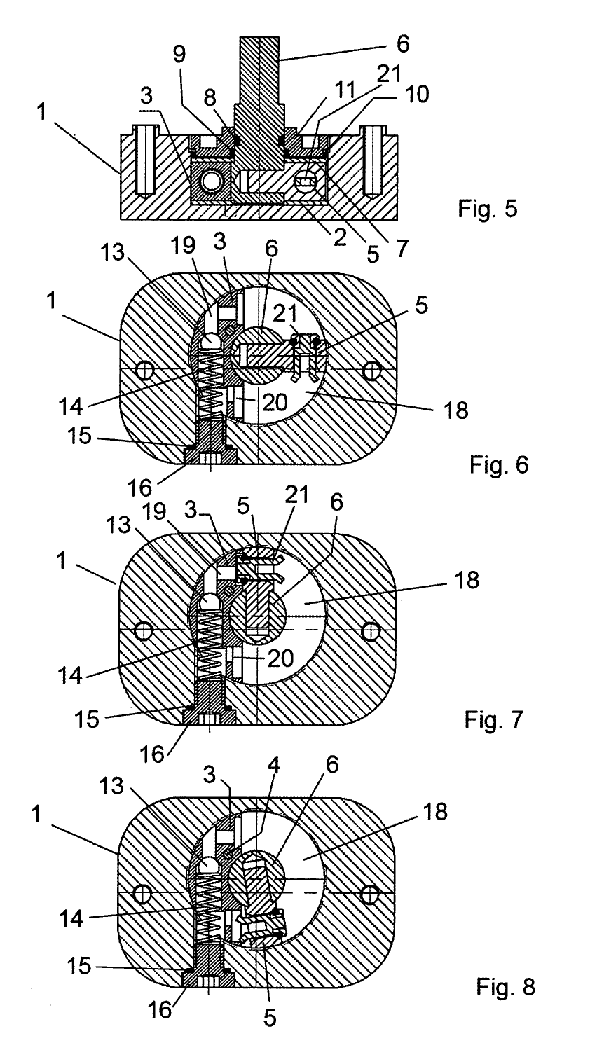

Extending through the rotary piston is a flow restrictor 21. As shown in FIG. 5 the flow restrictor 21 is of similar or smaller cross-sectional size than the open flow path through the one-way valve 3.

With reference to FIGS. 6 to 8, when the lid 17 is lifted open, the shaft 6 rotates anticlockwise. As a result, the rotary piston 5 moves anticlockwise toward the inlet port 19. During slow lifting of the lid 17 an anticlockwise moment is induced in shaft 6. A small volumetric flow rate of hydraulic fluid passes downwardly through the flow restrictor 21. If the lid is opened more rapidly, hydraulic pressure builds up above the piston 15 as a result of limited pressure relief afforded by the flow restrictor 21. The ball 13 therefore compresses the spring 14 and moves away from its seat to allow hydraulic fluid to flow past the ball 13 en route to the exit port 20 where it is returned to the hydraulic chamber at the bottom side of the rotary piston 5.

Upon release of the lid 17, hydraulic pressure builds up beneath the piston 5 as a result of the clockwise moment about the shaft 6 induced by the mass of the lid 17, but the hydraulic fluid cannot backflow through the one-way valve 3 as the ball 13 is pressed hard against its seat. The hydraulic fluid beneath the piston passes upwardly through the flow restrictor 21 which is the only path through which the hydraulic fluid can flow during clockwise motion of the shaft 6. As a result, the lid 17 lowers slowly to its rest position.

It should be appreciated that modifications and alterations obvious to those skilled in the art are not to be considered as beyond the scope of the present invention. For example, a one-way valve could be provided upon the rotary piston and the flow restrictor could be provided at a fixed location with respect to the hinge block. Furthermore, instead of providing a separate flow restrictor through the rotary piston 5, a small gap could be provided at the periphery of the piston past which hydraulic fluid could flow. Furthermore, it is not necessary to provide a pair of hydraulic hinge blocks. A single hinge block may suffice and a simple pivot could be provided in the opposite position.

1. A hydraulic hinge for a lid of a food serving vessel, comprising:
a hinge block,
a shaft pivotally mounted to the hinge block,
an annular hydraulic chamber within the hinge block and at least partially surrounding the shaft, and
a one-way valve having an inlet port and an outlet port each communicating with the hydraulic chamber and allowing hydraulic fluid to flow from the inlet port to the outlet port but not vice versa.

2. The hinge of claim 1, further comprising a rotary piston extending from the shaft across the annular hydraulic chamber and adapted to pivot with the shaft between the inlet and outlet ports and comprising a flow restrictor allowing hydraulic flow therethrough.

3. The hinge of claim 1 wherein the one-way valve comprises a spring and a ball situated between the inlet and outlet ports.

4. The hinge of claim 1, further comprising a seal plate through which the shaft passes and a sealing to the hinge block.

5. The hinge of claim 4, further comprising a hinge block cover through which the shaft also passes and attached to the hinge block and covering the seal plate.
